(19) United States
(12) Patent Application Publication
(10) Pub. No.: US 2006/0032439 A1
(43) Pub. Date: Feb. 16, 2006

(54) Device for applying a cosmetic product to the human body

(75) Inventors: Flavio Burato, Fara Vicentino (IT); Fabio Durighel, Montebelluna (IT); Silvio Gusmini, Treviglio (IT); Bruno Orlandi, Bresso (IT)

Correspondence Address: GREER, BURNS & CRAIN, 300 S WACKER DR, 25TH FLOOR, CHICAGO, IL, 60606, US

(73) Assignee: Riversdale Investments Limited

(21) Appl. No.: 11/190,756

(22) Filed: Jul. 27, 2005

(30) Foreign Application Priority Data
Aug. 10, 2004 (IT) TV2004A000096
Jan. 31, 2005 (IT) TV2005A000015

(51) Int. Cl. B05B 12/00; B05B 15/12; A61H 9/00

(52) U.S. Cl. 118/712; 118/326; 118/313; 4/597; 601/154; 132/333

(57) ABSTRACT

A device for applying a cosmetic product to the human body, constituted by at least one first column, which is arranged in an open space and is provided with a plurality of nozzles whose height can be adjusted for spraying a beneficial or cosmetic product that has been electrically precharged. The device further comprises a stand for the user, which is connected electrically to the ground at the post-positioning regions.

The present invention relates to a device for applying a cosmetic product, such as a product for tanning or a beneficial product, to the human body. Research aimed at achieving a suntan without the need for prolonged exposure to sunlight, which also comprises ultraviolet radiation that can be harmful to the health, has led to the development of so-called self-tanning products, usually constituted by creams capable of stimulating autonomously the reactions of the body that cause human skin to tan. In order to ensure good uniformity of the coloring of the skin that can be obtained by using these products, which are generally available as creams or lotions, they must be applied to the skin uniformly over the entire body, and this operation is difficult if it is performed manually by spreading the product. As a partial solution to this drawback, it is possible to apply self-tanning products by means of known kinds of tanning device, which apply the product in the form of a fine dispersion of particles, which can thus be distributed more uniformly and provide more uniform tanning.

### BACKGROUND OF THE INVENTION

It is in fact currently known to use a first type of a body coating device, disclosed in document WO 00/54892 (U.S. Pat. No. 6,387,081), which is constituted by a closed enclosure, inside which a supporting frame is inserted for an electrostatic nozzle for vaporizing, inside the closed enclosure, and electrostatically charging a liquid to be applied to the human body. When said liquid passes through the nozzle, it is vaporized into droplets, which are charged electrostatically. A fine mist is thus formed by virtue of the vertical and horizontal motion imparted to the nozzle. An electrostatically charged fine mist thus forms inside the enclosure. Inside said enclosure there is a connection for grounding the human body, so as to facilitate the deposition thereon of the liquid that has been vaporized and charged electrostatically by means of the electrostatic nozzles. Once the particles or droplets have left the nozzle, they lose speed, and therefore for example once they have traveled beyond the body of the user they tend, by gravity, to fall toward the bottom of the enclosure and to cling to its walls; this fact charges electrostatically the walls of the enclosure, so that new droplets that tend to deposit on the walls are repelled by them. As an alternative, the walls can be precharged electrostatically.

In a second embodiment of this first known type of application device, the closed enclosure comprises a first wall, on which the supporting frame for the electrostatic nozzle is positioned, and a second wall, which is arranged approximately in front of said first wall and comprises at least one curved portion. The main drawback of this first known type of tanning device consists of the fact that in order to ensure the generation of a cloud or mist of electrostatically charged droplets or particles capable of completely surrounding the body of the user by means of a single nozzle, it requires the vaporization of a large quantity of self-tanning liquid, which is deposited only partially on the body of the user, causing considerable waste and high operating costs. Another drawback of this first known type of tanning device relates to the fact that since the product is vaporized in an amount that exceeds by far the amount actually deposited on the body of the user, it necessarily requires the indispensable presence of a closed enclosure in order to confine the cloud of vaporized product around the body of the user; said enclosure is further optionally provided with walls that are or can be charged electrically. Another drawback of this first known type of tanning device relates to the fact that the presence of a closed enclosure, inside which the user must be placed, can induce in some individuals a state of unease or fear, which prevents use of said device. Another drawback is that if the walls are electrostatically precharged, a layer of liquid is deposited thereon and, once the device is deactivated, drips toward the bottom of the enclosure and must therefore be removed both from the bottom and from the walls in order to obtain a clean enclosure and avoid the formation of deposits once the liquid has dried. Moreover, if the walls are electrostatically charged, there still is the problem for the user of not touching them, since he is electrostatically grounded. Another drawback of this first known type of device is that the closed enclosure requires considerable space for its placement, making it difficult and onerous to arrange it within private or commercial spaces.

Document WO 98/52452 is also known which discloses a second known type of device for tanning the human body, which is constituted by a closed enclosure inside which there is an application region optionally formed by internal walls. At said application region there is, on the walls of the closed enclosure, a plurality of dispensers whose height can be adjusted and whose position is defined by means of an adjustable arm that is capable of detecting the height of the shoulders of the user, so as to prevent spraying the product in the region of the head of said user. This second known type of tanning device has some of the drawbacks already mentioned in the previous background art, and the dispensers are furthermore located on the walls of the region of application, so that they are arranged at a preset distance from the body of the user and face said user on multiple sides; if one wishes to provide a uniform distribution within the entire application region, particularly at “hidden” areas such as those at the inner sides of the legs, it is therefore necessary to vaporize a large quantity of the product to be deposited, causing considerable waste.

A third known type of device for spraying a cosmetic composition is disclosed in document WO 03/074188; it is constituted by a manual electrostatic dispenser, which comprises a nozzle, a tank for the product to be applied, means for conveying said product in the liquid state to the nozzle, and a high-voltage circuit capable of charging electrically the product atomized by the nozzle. Said nozzle is of the slit type and has an aperture comprised between 0.05 and 0.5 millimeters. The main drawback of this third known type of device is that uniform application of the product is difficult when said product is operated directly by the user, making it preferable to have a second person present. Another drawback consists of the fact that if the user is not electrically connected to the ground, the effectiveness of the electrostatic charging of the vaporized product is small, causing a low efficiency in the deposition of the product and therefore a high consumption thereof.

Absolute safety may also not be assured in the above mentioned devices since it is always possible for the user to accidentally touch the spray heads at which the spray liquid is electrostatically charged.

Some partial solutions to the above mentioned drawbacks may be found in known devices that provide enclosures with openings, in the form of an open booth, and electrostatic charging of the spray liquid at locations away from the spray heads.

### SUMMARY OF THE INVENTION

The aim of the present invention is to solve the above-mentioned problems, eliminating the drawbacks of the cited background art, by providing a device that allows to achieve efficient deposition of a beneficial or cosmetic product, for example a self-tanning product, a (hyper) pigmentation removal or bleaching product on the body of a user, providing limited dispersion of said product.

Within this aim, an object of the invention is to provide a device that allows uniform application of the cosmetic product to the body of the user.

Another object of the invention is to provide a device with easy access for the user as well as great freedom of movement and the possibility to exit quickly and easily therefrom at any time and that imparts a feeling of comfort and safety.

Another object is to provide a device that allows automatic adjustment of the quantity and type of cosmetic product to be applied to the body of the user and in particular a device that allows dispensing the product in the form of droplets of a selected size, with a jet having a selected angular breadth.

Another object of the invention is to have limited dimensions, so as to allow its easy and simple placement.

Another object is to provide a device that allows to reduce drastically maintenance costs for cleaning it of the residues of sprayed products.

Another object is to provide a device that preserves the user, who is electrically grounded, from contact with electrostatically charged parts other than the vaporized product.

Another object is to provide a device that is structurally simple and has low manufacturing costs.

This aim and these and other objects that will become better apparent hereinafter are achieved by a device for applying a cosmetic or beneficial product to the human body, comprising at least one first column, which is arranged in an open space and is provided with a plurality of nozzles for spraying a self-tanning or cosmetic product that has been electrically precharged, the device comprising a stand for the user, with foot-positioning regions connected electrically to the ground.

### BRIEF DESCRIPTION OF THE DRAWINGS

Further characteristics and advantages of the invention will become better apparent from the following detailed description of a particular but not exclusive embodiment thereof, illustrated by way of non-limiting example in the accompanying drawings, wherein:

FIGS. 1, 2 and 3 are respectively a front perspective view, a top perspective view and a rear perspective view of a device according to the invention;

FIG. 4 is a sectional view, taken along a vertical plane, of a detail of the device according to the invention;

FIG. 5 is a schematic view of a hydraulic circuit that is part of the device;

FIGS. 6, 7, 8 and 9 are four cross-sectional views, of spray elements of the device according to the invention;

FIG. 10 is a side view of a detail of a nozzle support of the device according to the invention;

FIG. 11 is a schematic view of a pneumatic circuit that is part of the device;

FIG. 12 is a sectional view, taken along a vertical plane, showing schematically the spraying system of the device according to the invention;

FIG. 13 is a sectional view, taken along a vertical plane, of a drying system of the device according to the invention;

FIG. 14 is an exploded perspective view of a further embodiment of spray element for the device according to the invention;

FIG. 15 is a longitudinal sectional view of the spray element of FIG. 14.

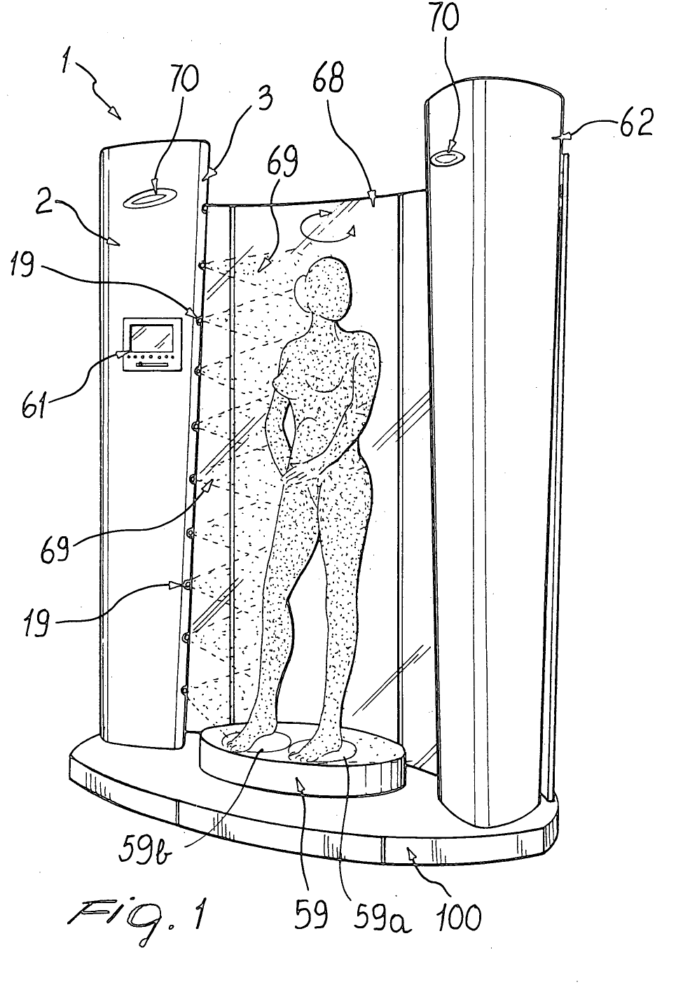

### DESCRIPTION OF THE PREFERRED EMBODIMENTS

In the embodiments that follow, individual characteristics, given in relation to specific examples, may actually be interchanged with other different characteristics that exist in other embodiments. Moreover, it is noted that anything found to be already known during the patenting process is understood not to be claimed and to be the subject of a disclaimer.

With reference to the figures, the reference numeral 1 designates a device for applying a cosmetic or beneficial product to the human body, which comprises a first column 2, which is arranged approximately vertical in an open space and rests on a base or footing 100.

The column 2, which is internally hollow, can be constituted conveniently by a profiled element that has for example an approximately triangular shape in plan view, with rounded corners, on one of which there is a first vertical opening 3 that affects or extends over all or part of one of said rounded corners; the column 2 is closed at its upper end by means of a first plug 2a.

First means for storing and circulating a self-tanning or cosmetic product 4 in the liquid state in the form of a storing apparatus is provided inside the first column 2 and comprises a hermetic tank 5, which is preferably approximately cylindrical and laterally to which there is a vertically-arranged transparent duct 6 for viewing the level of the product 4, which is connected to the inside of the tank proximate to the upper and lower ends of said tank.

Advantageously, the tank 5 rests on feet, which are not shown in the accompanying figures, are made of electrically insulating material and act as insulators between the tank 5 and the footing 100, preventing such tank 5 from discharging to the ground the electrostatic charge that is present in the liquid product 4 contained therein, after said liquid has been charged electrically, as described hereinafter.

A first supply valve 8 and a second safety valve 9 are provided on the upper surface 7 of the tank 5 and are connected to the inside of said tank; said second valve can be adjusted preferably in order to act when the pressure inside the tank 5 exceeds approximately 2.5 bars.

Moreover, a third inflow valve 10 for the inflow of the product 4 and a fourth outflow valve 11 for the discharge of the product are further arranged laterally with respect to the tank 5 and respectively proximate to the upper and lower ends of the tank 5, and are connected to the inside of said tank.

Proximate to the lower end of the tank, preferably in an upward position with respect to the fourth outflow valve 11, there is a fifth air valve 12 for introducing compressed air into the tank 5.

The first means or storing apparatus for storing and circulating the product 4 is provided with a circulation apparatus including a hollow rigid pipe 13, which is constituted by a hollow and rigid cylindrical element that is arranged vertically within the first column 2 proximate to the first opening 3.

Conveniently, the pipe 13 is lower than the first column 2, so as to be contained completely inside it, and can be made for example of PVC (polyvinyl chloride).

The pipe 13 is closed permanently at its lower end 14 and is closed at its upper end 15 by means of a second optionally removable plug 13a, in which there is a first through hole. The pipe 13 is connected, proximate to its lower end 14, to the tank 5 by means of a first duct 16, which is connected to the tank by means of the fourth valve 11; a second duct 17 connects the pipe 13, proximate to its upper end 15, to the tank 5 by means of the third valve 10.

Conveniently, inside the second duct 17 it is possible to arrange a sixth one-way valve 18, which is suitable to allow the product 4 to flow inside the pipe 13 only upward, so that the liquid product 4 can exit from the tank 5 only at the fourth valve 11 and returned into the tank only through the third valve 10.

On the side wall of the pipe 13 there are a plurality of spray elements in the form of nozzles 19, which are distributed vertically along all or part of said wall; each nozzle is connected to the interior of the pipe by interposing a pneumatic valve 20 of the normally-closed valve, and said nozzles are directed toward the outside of the first column 2 through the first opening 3.

It is possible to provide one or more such nozzles.

In an advantageous but not exclusive embodiment, three nozzles 19 are provided on the pipe 13 and are approximately mutually equidistant in a vertical direction.

Each nozzle 19 is constituted by an approximately cylindrical hollow shell 21, inside which there is an approximately cylindrical receptacle 22, which is open toward the outside, at a first opening, at a first rear end face or base 23 of the shell 21 and is at least partially threaded proximate to said first base.

At the second end face 24 of the shell 21, which lies opposite the first end face 23, the receptacle 22 is open toward the outside by means of a second opening 25, which is preferably circular and flared outward.

On the side wall of the shell 21 there is also a second hole 26 for introducing compressed air in the receptacle 22.

Conveniently, the shell 21 can be constituted by a first approximately cylindrical hollow half-shell 21a and by a second circular half-shell 21b, which is provided with a central hole; said half-shells can be easily separated from each other in order to facilitate maintenance operations.

Each nozzle 19 further comprises an internal body 27, which can be inserted within the receptacle 22 and has a cylindrical fixing region 27a, which has approximately the same diameter as the receptacle 22 and has, on its side wall, a thread that matches the thread formed on the receptacle 22; further, a first frustum-shaped head 27b is formed on said internal body and is adjacent to the fixing region.

A first channel 28 is formed axially with respect to the internal body 27 along its entire length and is open at the opposite ends of said internal body.

A diffuser 29 is further associated with the internal body 27 and is constituted by a cylindrical body 30, inside which there is a conical receptacle 30a, which is open at both end faces of said diffuser; advantageously, at its top, said conical receptacle forms, on a first end face 31 of the cylindrical body 30, a third hole 32, which has a diameter preferably comprised between approximately 0.5 millimeters and approximately 0.6 millimeters.

The diffuser 29 further comprises a ring 33, which is arranged concentrically with respect to the cylindrical body 30 proximate to its first end face 31 and supports, in cooperation with the cylindrical body 30, a plurality of first vanes 34, which are arranged approximately radially.

The diffuser 29 is associated with the internal body 27 by means of a plurality of axial tabs 35, which can be inserted within the first channel 28 at the first head 27b; advantageously, the ring 33 has a larger diameter than the first head 27b at the end of the internal body 27.

Moreover, a centrifugal element 36 is inserted in the first channel 28 and is constituted by a second cylindrical head 36a, which has an outside diameter that is approximately equal to the inside diameter of the first channel 28 and can be connected rotatably thereto for example by means of an appropriate thread, and by a stem 36b, which is also cylindrical and has a smaller outside diameter than the second head 36a and protrudes axially therefrom.

A second channel 37 is provided in, and axially with respect to the centrifugal element 36 so as to affect or extend at the second head 36a along its entire length and the stem 36b along part of its length, and is open at the end of the second head 36a that is directed away from and not connected to the stem 36b.

Proximate to the free end 38 of the stem 36b there is a third radial channel 39, which is connected to the second axial channel 37 so that it is also connected to the first channel 28; moreover, on the free end 38 of the stem 36b there are a plurality of slots 40, which are inclined with respect to the longitudinal axis of the nozzle and are suitable to connect to the free end 38 of the stem 36 the second channel 37 and the third channel 39.

Advantageously, the shell 21, the internal body 27, the diffuser 29 and the centrifugal element 36 can be made of dielectric and optionally antistatic material, so as to limit the interference of the nozzles 19 with electrostatic fields.

The pneumatic valves 20, interposed between the nozzles 19 and the pipe 13, are of the normally-closed type, so that when they are not activated they prevent the outflow of the liquid product 4 contained inside the pipe 13.

As an alternative, the storing apparatus for storing and circulating the product 4 do not include the pipe 13, the nozzles 19 and the pneumatic valves 20, but include a series of pipes, that connect in a known way the third valve 10 and the fourth valve 11 of the tank 5 to a series of spray guns of a known type, which are actuated by means of electric valves and compressed air lines; said spray guns are typically made of antistatic plastic material and comprise an intake for the liquid product 4, an intake for the spraying air to be mixed with the liquid product 4, and an intake for the air that controls the activation of the spray gun.

Further, said spray guns comprise a mixing chamber, in which the spraying air and the liquid product 4 are mixed at pressures that are typically lower than the pressures required when using the nozzles 19; typical values of these pressures are for example approximately 0.7 bars for the spraying air and approximately 0.6 bars for the liquid product 4.

The use of lower pressures allows to limit the value of the voltage required to charge electrically the particles of liquid product 4, thus reducing the energy consumption of the device for tanning the human body 1 and increasing user safety.

In these known types of spray gun, the liquid product 4 exits from a hole, which is closed by a needle when said gun is not active; the presence of the needle helps to keep said hole clean by removing, every time it is used, any deposits of product 4 that might form and compromise the intensity or the shape of the jet of liquid product 4 that is dispensed.

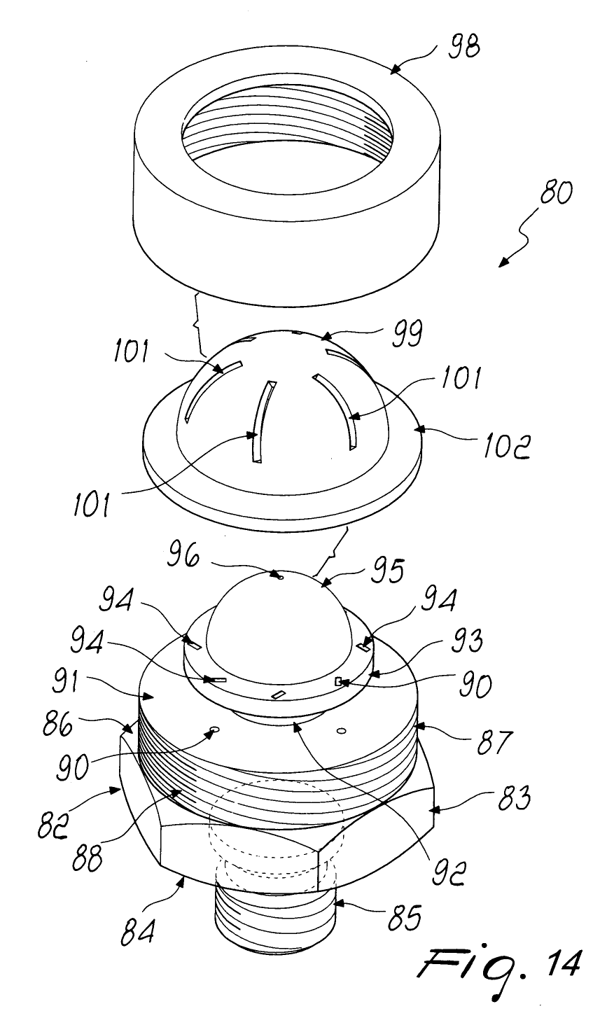

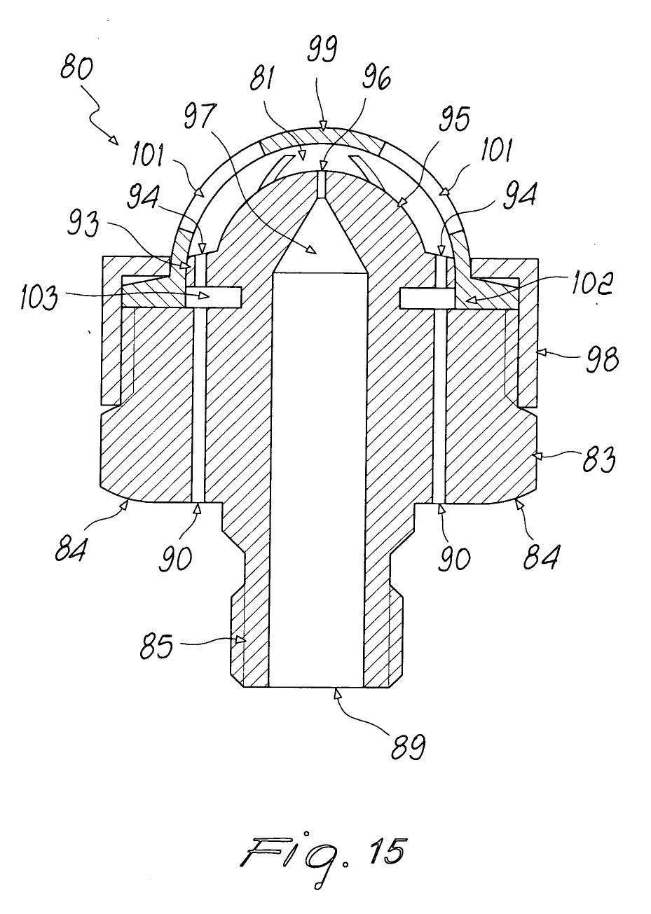

An embodiment of a spray element in the form of a nozzle that may function at adjustable, low pressures is hereinafter described with reference to the FIGS. 14-15, in which the nozzle is designated by the reference numeral 80. Such nozzle 80 is mountable for use with the device, according to the invention, instead of the nozzle 19.

The nozzle 80 comprises a cylindrical body 82, from which a plate 83 protrudes radially, said plate being shaped approximately like a prism having a hexagonal base, from the first lower end face 84 of which there protrudes, approximately at right angles thereto, a preferably cylindrical and hollow pin 85 for fixing the cylindrical body 82 to the device for applying the cosmetic product.

A cylinder 87 protrudes from the second upper end face 86 of the plate 83 and has a threaded outer lateral surface 88.

The cylindrical body 82 is provided with a first axial channel 89 for feeding said liquid, which passes longitudinally through the pin 85, the plate 83 and the cylinder 87.

The cylindrical body 82 is further provided with second axial channels 90 for feeding air, which pass longitudinally through the plate 83 and the cylinder 87 in a region located laterally with respect to the first channel 89.

A first cylindrical element 92 protrudes from the third upper end face 91 of the cylinder 87, approximately centrally thereto, and is internally hollow and connected to the first channel 89, which has a smaller diameter than the third end face 91, and is followed or continued by a shank 93, which has a transverse cross-section that is advantageously but not necessarily rectangular and has an outside diameter that is smaller than the diameter of the third end face 91 of the cylinder 87.

A plurality of through ducts 94 are provided on the shank 93, are connected to the second channels 90, and are advantageously distributed so as to be approximately mutually equidistant on the shank 93; preferably but not necessarily, the ducts 94 are provided along axes that are inclined with respect to the longitudinal axis of the shank 93.

The ducts 94 can be provided at, and inside the shank 93.

The shank 93 protrudes radially from the lower end of a dome 95, which is advantageously hemispherical and hollow and has an upper opening 96 that is connected to the first channel 89 and is suitable to allow the liquid to escape from the dome 95.

The dome 95 is in fact provided internally with a cavity 97, which is connected to the inside of the first cylindrical element 92 and therefore to the first channel 89, which preferably but not necessarily tapers toward the upper opening 96 and is thus substantially frustum-shaped.

A covering element 99 is detachably associated with the cylindrical body 82 at the third end face 91 by way of known fixing means, such as for example a ring 98 that can be associated with the complementarily threaded lateral surface 88 of the cylinder 87; said covering element is advantageously shaped approximately complementarily with respect to the dome 95, and a chamber 81 is formed between the covering element 99 and the dome 95 and is connected to the outside through a plurality of lateral outlet slots 101.

Advantageously, the outlet slots 101 are distributed so that they are approximately mutually equidistant on the lateral surface of the covering element 99 and do not affect the region of the covering element 99 that faces the underlying upper opening 96 provided in the dome 95, i.e. such region of the covering element 99, remains free of openings.

Advantageously, outlet holes may also be provided in the covering element 99.

An annular protrusion 102 protrudes from the outer lateral surface of the covering element 99 approximately at the lower perimetric edge thereof and has an outside diameter that is substantially equal to the diameter of the third end face 91 of the cylinder 87.

An annular chamber 103 is formed between the lower surface of the shank 93, the third end face 91 and the internal lateral surface of the covering element 99 and connects the second channels 90 and the ducts 94.

The ring 98 locks the annular protrusion 102 of the covering element 99 to the third end face 91

Operation of the nozzle 80 is therefore as follows: with reference to FIG. 14, the covering element 99 rests on the third end face 91 and is fixed to the cylinder 87 by way of the ring 98.

The nozzle 80 can then be applied to the device of the invention which is capable of sending said liquid under pressure to the first channel 89 and the pressurized air to the second channels 90.

The liquid passes through the first channel 89 and the cavity 97 and then, through the upper opening 96, is injected into the chamber 81, colliding with the region of the covering element 99 that faces the upper opening 96 and then descending again toward the shank 93.

At the same time, the air is guided into the annular chamber 103 through the second channels 90 and is then propelled into the ducts 94 and, by traveling through them, assumes a rotary motion and enters the chamber 81.

In the chamber 81, the air makes contact with the liquid and mixes with it, the chamber 81 constituting so a mixing chamber; the pressures of the air and the liquid are balanced at a value that, advantageously, is not much higher than the ambient pressure and therefore the mixture flows out of the nozzle 80, through the slots 101 or other holes, in the form of minute droplets at a pressure that is not much higher than the ambient pressure.

The higher the pressure of the air in relation to the pressure of the liquid, the more the mixture tends to flow out of the slots 101 toward the upper end of the covering element 99.

Therefore, for high values of the ratio between the pressure of the air and the pressure of the liquid, the jet of mixture that is dispensed has a narrow angle and vice versa for low values of said ratio the jet has a wide angle.

By acting on the ratio between the pressures of the liquid and of the air it is therefore possible to obtain a jet having a selected angle breadth.

The application device 1 further comprises a pre-charging apparatus located upstream of the nozzles 19, particularly second pre-charging means suitable to precharge electrically the product 4 before spraying it; said second pre-charging means are constituted by an electrostatic device 41 including an electronic regulator, which is connected electrically to an electrostatic probe 42, which is preferably rod-like and can be inserted inside the pipe 13 through the first hole formed in the second plug 13a.

The electrostatic probe 42 is thus immersed in the product 4, which is present in the liquid state inside the pipe 13; its activation by means of the electrostatic device 41 allows to charge electrically all of the liquid that is present inside the first means for storing and circulating the product 4. As an alternative, the probe can be arranged at the tank 5.

Particularly advantageous results can be achieved by using an electrostatic device that emits, under the control of its electronic regulator, by means of a probe, a positive voltage preferably between approximately 40,000 and 60,000 volts, which generates an electrical field around itself, positively charging the liquid.

Lower voltages however can be used also, in view of the mentioned low operation pressures.

Advantageously, said electrostatic device can be arranged within the first column 2, above the tank 5.

The tanning device 1 according to the invention further comprises third, lifting means for lifting and lowering the nozzle or nozzles, which are constituted by a pneumatic cylinder 43, which can be supplied with compressed air, is arranged vertically and rests on the footing 100.

The pneumatic cylinder 43 comprises a vertically movable slider 44, on which the lower end 14 of the pipe 13 rests and is permanently coupled thereto.

Moreover, the pneumatic cylinder 43 is provided with a plurality of position sensors 45, which are arranged at preset heights along the stroke of the slider 44 and are capable of detecting the passage of said slider.

Said position sensors can be constituted for example by microswitches and can be preferably arranged so that they are vertically equidistant; an advantageous but not exclusive embodiment provides for the presence of five microswitches, which are vertically mutually equidistant with a spacing of approximately 50 millimeters.

The device 1 for tanning the human body further comprises fourth product delivery control means in the form of a product delivery control apparatus for pressurizing the product 4, for recharging the tank 5, for adjusting the outflow of the stream of the product from the nozzles and for atomizing it, for activating the second pre-charging means suitable to electrically precharge the product, and for actuating the pneumatic cylinder 43.

Said fourth means comprise a pressurization device, which is constituted by a compressor 46a, which supplies a bottle 46; in a preferred but not exclusive embodiment, the air is stored inside the bottle 46 at a pressure of approximately 8 bars. The fourth means further comprise a first electric valve 47, which is supplied by the bottle 46 and is connected, by means of a first pressure pipe 48 connected to the fifth valve 12, to the inside of the tank 5.

Conveniently, the first electric valve 47 reduces the pressure inside the first means for storing and circulating the product 4 to an adjustable value of approximately 2 bars, introducing in the upper part of the tank 5 a pocket of compressed air 49, which pressurizes all of the underlying liquid product 4.

A second electric valve 50, supplied by the bottle 46, reduces, when activated, the pressure to approximately 1.5 bars and can be connected detachably to a canister for refilling the tank 5; when one wishes to replenish the amount of liquid product 4 that is present inside the tank 5, it is sufficient to transfer the chosen amount of product from the canister by connecting it to the second electric valve 50.

Further, the fourth means comprise a third electric valve 51, which is supplied by the bottle 46 and is connected, by means of a second pressure pipe 52, to each one of the pneumatic valves 20 interposed between each nozzle 19 and the inside of the vertical pipe 13.

Advantageously, said third electric valve, when activated, reduces the pressure that acts on the pneumatic valves to a value that is preferably comprised between approximately 2 bars and approximately 3 bars; this pressure causes the selective opening of said pneumatic valves, allowing the flow of the product 4 contained inside the pipe 13 toward the nozzles 19.

A fourth electric valve 53, supplied by the bottle 46, is connected by means of a third pressure pipe 54 to the nozzles 19 by means of the second hole 26 provided in the shell 21; said fourth electric valve, which can be activated selectively, provides a flow of air at a pressure that is preferably comprised between approximately 3 bars and approximately 4 bars for atomizing the product 4 that flows within the nozzles 19.

The fourth means further comprise a fifth electric valve 55, which is connected by means of a fourth pressure pipe 56 to the electrostatic device 41 for the selective activation thereof; advantageously, said fifth electric valve also performs a pressure reduction, preferably to a value of approximately 2 bars.

A sixth electric valve 57, supplied by the bottle 46, is connected by means of a fifth pressure pipe 58 to the pneumatic cylinder 43; its selective activation allows an upward or downward vertical translational motion of said cylinder and to maintain the position that has been reached.

A stand 59 for the user is provided on the footing 100, proximate to the column 1, is made of an electrically conducting material and is electrically connected to the ground.

As an advantageous alternative, grounding can be provided only at two individual foot-positioning regions 59i a, 59b where the sole of the foot rests.

Conveniently, the stand 59 or the foot positioning regions 59a, 59b can comprise a scale S for automatically detecting the body weight of the user.

The stand 59 may further rotate advantageously but not necessarily through a full circle about an axis that is perpendicular to its plane of arrangement, thus allowing the user located thereon to gradually direct the various regions of his body toward the spray of the nozzles 19 without having to turn by himself.

Moreover, the use of a rotating stand 59 allows to optimize the spraying activity, since the jet of liquid and electrically charged product 4, by affecting in succession the entire body of the user, can have a very small angular span on the horizontal plane with respect to the case of a fixed stand 59; this allows to further reduce the amount of dispersed liquid product 4.

For example, an angular span of approximately 30 degrees of the jet is sufficient to ensure uniform distribution of the liquid tanning product 4 on the body of the user.

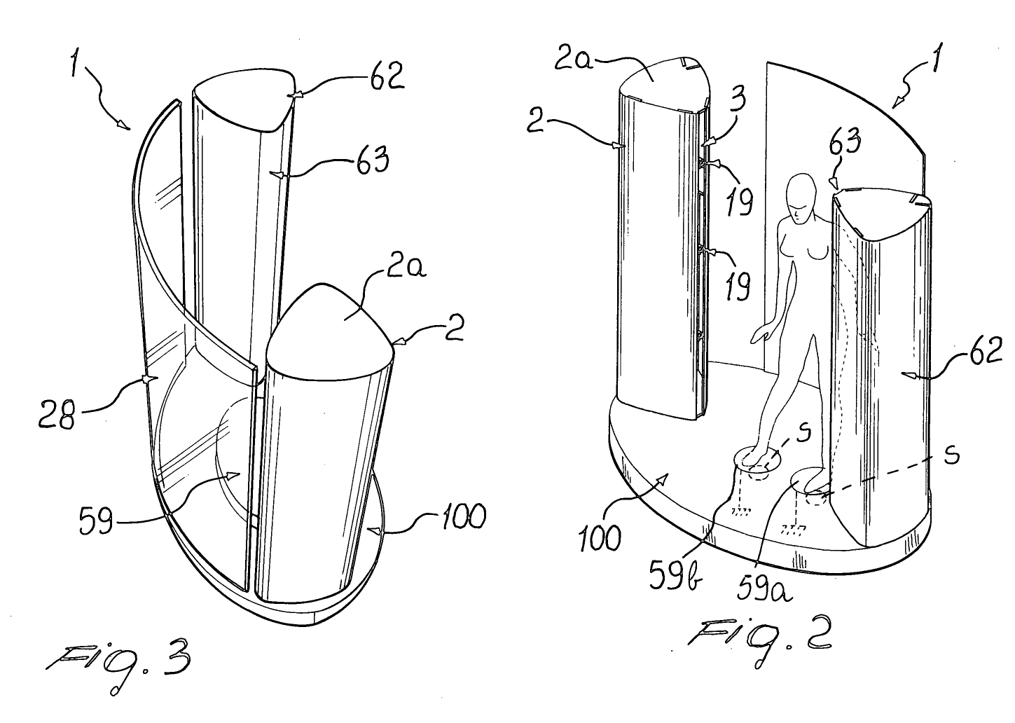

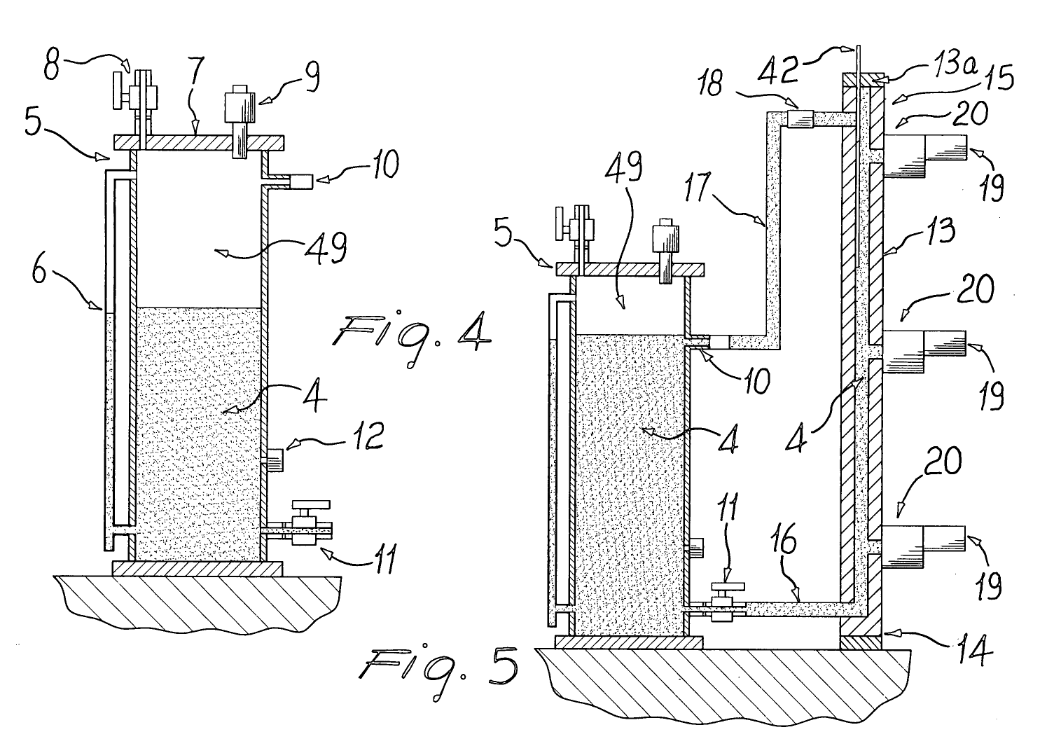

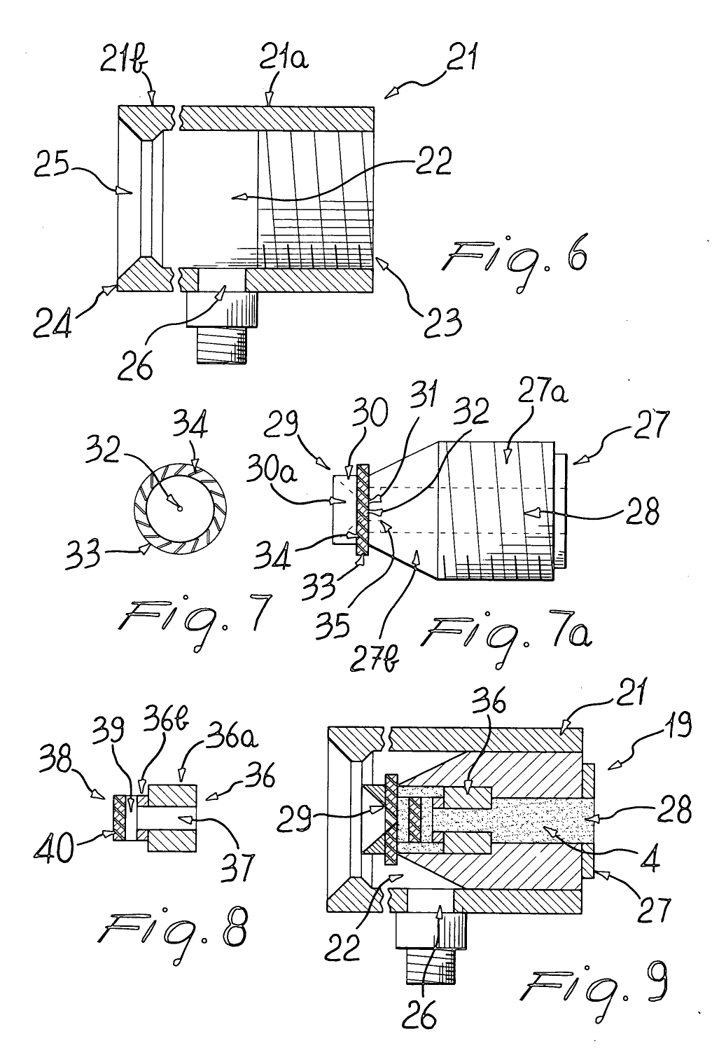

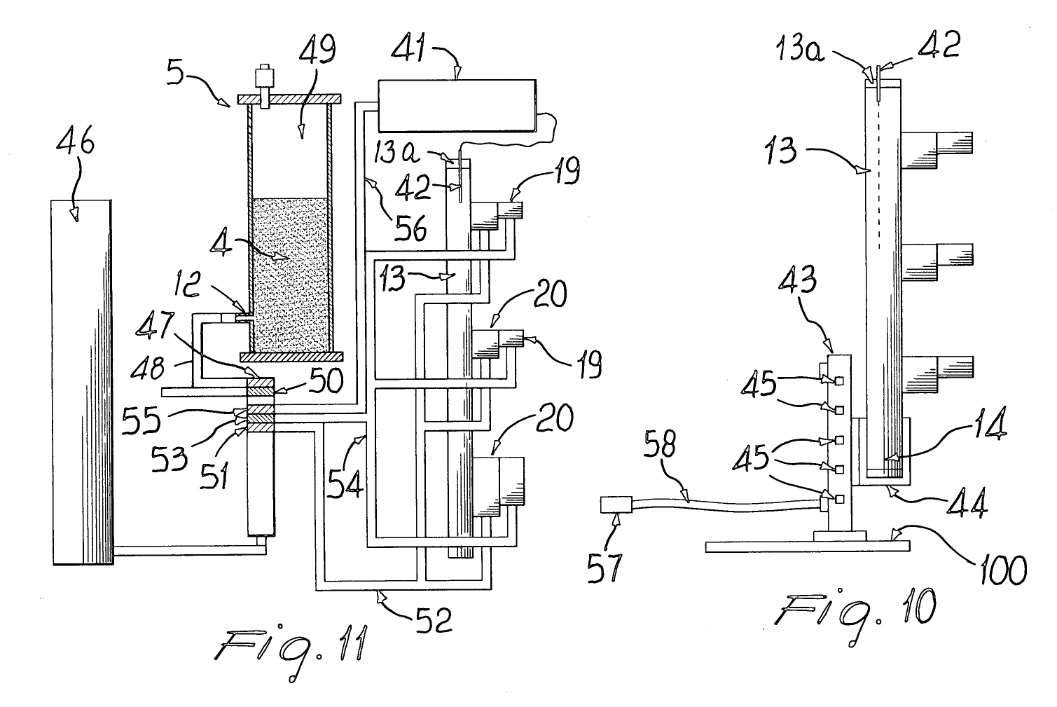

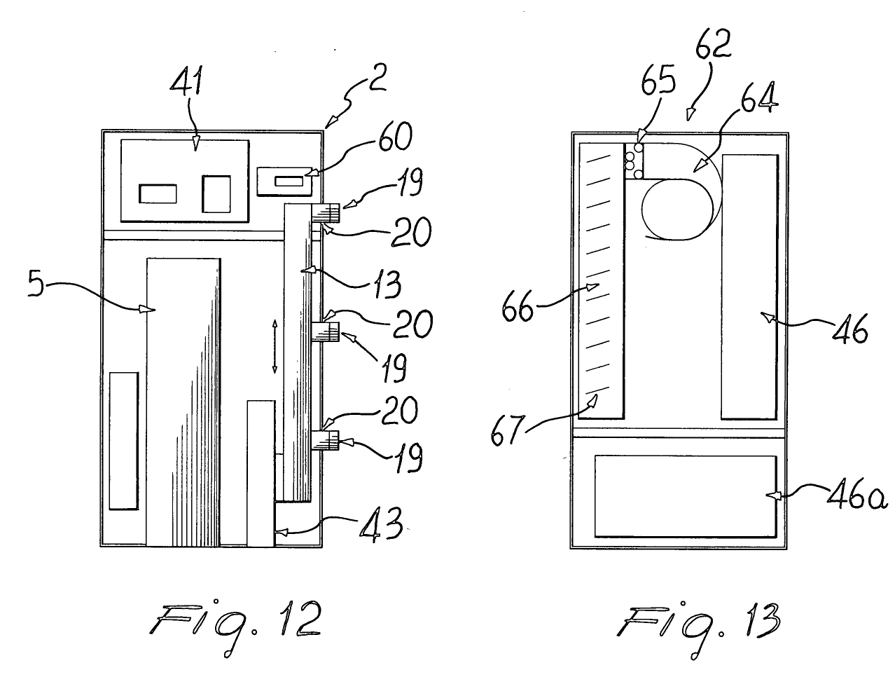

As an advantageous alternative to the stand 59 the two individual foot positioning regions 59a, 59b provided at the upper surface of the base 100, as shown in FIG. 2, which are made of electrically conducting material, are electrically connected to the ground, and have dimensions comparable to those of the user's feet; said plates can have, for example, an approximately elliptical shape, with axes measuring for example 350 millimeters and 180 millimeters respectively.

Each one of said regions may be independently connected to the ground, and isolated from the base 100.

Advantageously but not necessarily, said regions 59a, 59b can be made of stainless steel of the AISI 314 type.

Advantageously, the surface of each one of said regions 59a, 59b that is directed toward the sole of the user's foot may be provided with means for improving the stability of the support of said foot, constituted for example by a plurality of sanded bands.

The use of the regions 59a, 59b reduces the surface of electrically conducting material that is exposed to the air, consequently reducing the amount of liquid and electrically charged product 4 that is attracted by said surface and is therefore wasted with respect to the case in which an electrically grounded single stand 59 of larger size is used.

Moreover, more focused and efficient application of the product can be achieved at the inner sides of the legs of the user.

Further, the device for tanning the human body 1 comprises fifth electronic means in the form of an electronic apparatus configured for the management of said device, for control and/or for displaying data, for controlling audio/video sources, for calculating body weight, for reading portable memory devices, and for computing spraying cycles.

Said fifth electronic means are constituted by a processing unit 60, which is arranged within the first column 2, preferably proximate to its upper end, which is connected electrically to the first, second, third, fourth, fifth and sixth electric valves and is capable of activating selectively each one of said valves according to preset sequences and for preset time intervals, so as to provide chosen work cycles.

Further, the processing unit 60 is connected to the electrostatic device 41 and is capable of selectively sending an impulse thereto for its activation and for adjusting the electrical field induced by the electrostatic probe 42 on the product 4.

The processing unit 60 is connected to an interface device 61, which is constituted preferably by a display with a keypad and means for reading portable memory devices, such as for example solid, magnetic or optical memories, for displaying, reading and/or storing and modifying data related to the body parameters of the user and to the work cycles to be performed, as well as for the maintenance of said tanning device.

The device 1 for tanning the human body may further comprise a second column 62, which is identical to the first column 2 and in which there is a third vertical opening 63, which is similar to the first opening 3 provided in the first column 2.

The second column 62 can be arranged on the footing 100 at a selected distance from the first column 2, so that the first opening 2 and the third opening 63 for example face each other mirror-symmetrically.

Inside the second column 62 an air blowing apparatus is provided that comprises sixth means for blowing air, for drying the body of a user, comprising a fan 64, which is preferably positioned proximate to the upper end of the second column and is directed outward through the third opening 63.

Between the fan 64 and the third opening 63 there are interposed devices for heating the air that exits from the fan, constituted for example by one or more resistors 65 that can be heated electrically, and there is a diffusion channel 66, which is arranged vertically at the third opening 63 and is provided with a plurality of second vanes 67, which can optionally be orientated, in order to guide the stream of air that flows out of the fan in the intended direction.

As an alternative, the sixth means for blowing air can be constituted by a series of fans, which comprises for example six fans, not shown in the accompanying figures, which are arranged inside the second column 62 so as to affect approximately its entire height and therefore substantially the entire body of the user; in this manner, the efficiency and speed of the drying process are improved.

Advantageously, the compressor 46a and the bottle 46 can further be accommodated inside the second column 62.

It is further possible to provide, on the outer surface of the first and second columns, speakers 70 for playing back sound and music during the operation of the tanning device or for synthesized speech with which operation is explained to the user.

A screen 68, preferably made of transparent material and having a curved shape, which has a purely aesthetic function and may provide a certain privacy to the user, can optionally be interposed vertically in the rear region of the device 1, between the first column and the second column, leaving in any case open at the front the space in which the product is sprayed.

The operation of the device 1 for tanning the human body entails that the tank 5 is filled with liquid product 4, by transferring it from an appropriate canister by activating the second electric valve 50, which induces inside said canister a pressure of approximately 1.5 bars, drawing pressurized air from the previously filled bottle 46, so as to propel the liquid product toward the tank 5.

Once the tank 5 has been filled to the intended level, which can be detected visually by means of the transparent duct 6, it is possible to operate the first electric valve 47, which introduces, through the fifth valve 12, air at a pressure of approximately 2 bars into the tank, inducing the same pressure on the liquid product 4.

The placement of the fifth valve 12 proximate to the lower end of the tank 5 forces the air introduced in said tank to pass, as it rises, through the liquid product 4, to produce a bubbling action for mixing it continuously and preventing the occurrence of settling or unevenness within it.

If the pressure inside the first means for storing and circulating the product increases accidentally by more than a preset value, the intervention of the second safety valve 9 would allow to expel the excess air toward the outside environment and to reduce the pressure inside the tank 5 and inside the pipe 13.

The operation pressures are anyway providable at the nozzles 19 or 80, adjustable by way of the described valve system, at the most suitable values to achieve the desired droplets dimensions and jet breadths.

Once the tanning device 1 has been activated in this manner, the user can position himself barefoot on the stand 59, so that his body is connected electrically to the ground and therefore is electrically neutral.

Advantageously, a portable storage device can be connected to the interface device 61, transferring into the processing unit 60 the data stored therein, which relate for example to the weight and height of the user, to the amount of product 4 to be deposited on the body of said user, and to the spraying time.

As an alternative, the body weight of the user can be detected by means of the scale that is provided at the stand 59, or foot regions 59a, 59b, while the remaining data can be reported by the user himself to the processing unit 60 by means of the interface device 61, which is provided for example with a keypad or with a touch-sensitive screen.

Depending on the height of the user, the processing unit 60 can control the opening of the sixth electric valve 57, which by actuating the pneumatic cylinder 43 provides a suitable vertical arrangement of the pipe 13 and therefore of the nozzles 19, which can thus be positioned at a preset optimum height.

The body weight of the user and his height further allow to determine in advance the amount of product 4 that is needed for complete and uniform spraying on the user's entire surface.

The opening of the fifth electric valve 55, commanded by the processing unit 60, activates the second means suitable to electrically precharge the product 4 before it is sprayed.

All of the liquid product that is present inside the first means for its storage and circulation is thus electrically charged before it is optionally sprayed.

Therefore, the tanning device 1 can start automatically the spraying cycle, which is preferably divided into a first cycle half, for front spraying, and into a second cycle half, for rear spraying, and is followed by a drying cycle.

Each cycle half is composed of a first blowing step, during which only the fourth electric valve 53 is opened; a stream of pressurized air through the nozzles 19 is thus established which is designed to clean them of any deposits of product 4 that are present thereon.

This is then followed by a second atomization and spraying step, during which the actuation of the third electric valve 51 opens the pneumatic valves 20, allowing the flow of the product 4 contained inside the pipe 13 toward the nozzles 19 under the action of pressure that acts inside the pipe 13.

During said second step, the liquid product 4, already electrostatically precharged, flows inside the first channel formed axially with respect to the internal body 27 of each nozzle 19, until it encounters the centrifugal element 36, which induces thereon a selected rotation by means of the second and third channels 37 and 93 and the slots 40.

The liquid product thus rotated is then introduced again into the first channel at the first head 27b of the internal body 27, where it is then atomized by passing through the third hole 32, which has a selected diameter in order to achieve a preset volume of the particles of product expelled by the nozzle.

Said particles, which are already electrostatically precharged, are then atomized by mixing with the air that arrives from the second hole 26 and is guided through the first vanes 34, which also impart a chosen rotation to said air stream.

Providing the nozzles by using a dielectric and optionally antistatic material allows to avoid alterations of the electrostatic field that is present inside to the liquid product 4 during atomization and spraying.

An optional third blowing step is then performed in order to allow to remove any deposits of products that might dirty or clog the nozzles 19.

A recorded voice message requests the user, before starting the first cycle half for front spraying, to face the first column 2, so that the liquid that exits from the nozzles 19 can strike him from the front.

At the end of the first cycle half, a different voice message asks the user to turn through approximately 180 degrees, arranging himself so that his back is approximately directed toward the first opening 3; after a preset time interval, the second cycle half for rear spraying, constituted by the same steps provided for the first cycle half, thus begins.

Particularly advantageous results are achieved by providing a first cycle half that lasts longer than the second cycle half, thus achieving the spraying of a larger amount of product during said first cycle half.

During each spraying step, the electrostatic device 41 can be advantageously deactivated, since the liquid and precharged product 4 retains the electrostatic charge previously acquired long enough to allow to perform an entire cycle half.

In this manner, during each spraying step, the user is in no way in contact, not even indirectly, with any source of electrical charge, and is protected against any electrical phenomenon that might be potentially dangerous for his safety.

The particles of product 69 expelled by the nozzles, which retain the electrostatic charge previously imparted to them, move by inertia toward the body of the user; by having charges of the same sign, said particles further tend to move mutually apart, forming a cloud that tends to move toward the user.

Since the user is electrically connected to the ground, and in a preferred embodiment at each one of his legs, said particles are attracted only toward the user with a force that exceeds the force of inertia, being thus deposited all over the user homogeneously and uniformly, an optimum application being particularly achieved at the less exposed inner sides of the legs.

The presence of a plurality of nozzles facilitates the homogeneous diffusion of said particles; the possibility to adjust their vertical arrangement further allows to adapt their distribution according to the height of the user.

The high efficiency of the spraying process, together with the broad possibility to adjust the position of the nozzles and to exactly determine the amount of product required, allows to limit the amount of dispersed product, thus providing a low operating cost of the device 1.

At the end of the spraying cycle, a drying cycle is performed automatically by activating the sixth air blower means; said drying cycle allows to eliminate particles of product that have not been absorbed by the body of the user, who can therefore dress quickly at the end of the cycle.

The placement of the first and second columns in an open space further allows the user great freedom of movement, allowing him to feel at ease, untroubled and safe during the execution of the cycle and increasing the level of comfort that he perceives.

It has thus been found that the invention has achieved the intended aim and objects, a device for tanning the human body having been provided which allows to achieve efficient and uniform deposition of a cosmetic product, for example a self-tanning product, a (hyper)pigmentation removal product or a bleaching product, on the body of the user, providing a low dispersion of said product.

Another object achieved by the invention is to ensure a uniform application of the cosmetic product on the body of the user.

Another object achieved by the invention is to ensure easy user access thereto and a great freedom of movement and the possibility to exit easily and quickly from it at any time.

Another object achieved by the invention is to ensure that the user is very safe and highly protected against electrostatic phenomena that might be dangerous for his safety. Another object that is achieved is to allow automatic adjustment of the quantity and type of cosmetic product to be applied to the body of the user.

Another object that is achieved is to have limited dimensions, so as to allow its easy and simple placement. Another object achieved by the invention is to allow to reduce drastically the maintenance costs for cleaning it of the residues of sprayed products.

Another object that is achieved is to protect the user, who is electrically grounded, from contact with electrostatically charged parts other than the vaporized product.

It is noted that the device according to the invention is also suitable, with very positive effects on safety and ultimate construction/operation costs, to operate at pressures that are sensibly lower than for the known spraying devices.

The materials used, as well as the dimensions that constitute the individual components of the invention, may of course be more pertinent according to specific requirements.

The various means for performing certain different functions need not certainly coexist only in the illustrated embodiment but can be present per se in many embodiments, including ones that are not illustrated.

The characteristics indicated as advantageous, convenient or the like may also be omitted or replaced by equivalents.

The terms approximately or substantially are hereinabove intended to mean that the features to which they apply have the characteristics mentioned but for variations usual and known to those skilled in the pertinent art.

The disclosures in Italian Patent Application No. TV2004A000096 from which this application claims priority are incorporated herein by reference.

What is claimed is:

1. A device for applying a cosmetic product to the human body, comprising:
a base;
a first column supported by the base;
a plurality of spraying nozzles, attached to said first column;
an electrically pre-charged self-tanning or cosmetic product for spraying through said nozzles onto a body of a user, the product being pre-charged before spraying the product through said nozzles;
two individual foot-positioning regions supported by the base, each of the foot-positioning regions being configured to receive a user's foot, wherein the foot-positioning regions are electrically connected to ground.

2. The device of claim 1, comprising a second column provided with at least one delivery apparatus for outputting air.

3. The device of claim 1, comprising:
pre-charging apparatus configured to electrically pre-charge said product before spraying thereof.

4. The device of claim 3, further comprising:
electronic apparatus configured to manage the device, to control and/or display data, and to compute spraying cycles; and
an air blowing apparatus configured to blow air onto a user.

5. The device of claim 4, wherein said first column is internally hollow so as to enclose an inside space.

6. The device of claim 1, further comprising:
a storing apparatus configured to store said product in a liquid state, wherein the storing apparatus is located inside said first column, and wherein the storing apparatus includes a tank.

7. The device of claim 6, wherein the tank includes a transparent duct arranged vertically at a side thereof for viewing a level of said product, said duct being connected for communication with an interior of said tank, the tank being further provided with a first supply valve and a second safety valve on an upper surface thereof that are connected to the inside of the tank, said second valve being adjustable so as to act when a pressure inside said tank exceeds a preset value.

8. The device of claim 6, further comprising:
an inflow valve for inflow of said product;
an outflow valve for outflow of said product, said inflow and outflow valves being connected to the interior of said tank, and
an air valve for introducing compressed air into said tank.

9. The device of claim 5, further comprising:
a circulation apparatus configured to circulate said product from the tank to the nozzles, the circulation apparatus including a hollow rigid pipe.

10. The device of claim 8, further comprising a pneumatic valve of a normally-closed type, said plurality of said nozzles being provided on a lateral wall of said pipe, said nozzles being distributed vertically along at least part of said pipe.

11. The device of claim 11, wherein the plurality of nozzles is three said nozzles which are provided on said pipe and are distributed therealong vertically and mutually equidistant.

12. The device of claim 11, wherein each one of said nozzles includes a substantially cylindrical hollow shell and an internal body.

13. The device of claim 12, comprising a diffuser associated with said internal body and constituted by a cylindrical body having end faces and by a conical receptacle that is located inside and is open at both end faces of said diffuser.

14. The device of claim 13, wherein said shell, said internal body, said diffuser and said centrifugal element are providable made of dielectric end/or antistatic material.

15. The device of claim 9, wherein said pre-charging apparatus includes an electrostatic device connected electrically to an electrostatic probe, said electrostatic probe being immersed in said product in liquid state inside said pipe, said probe being further activatable by way of said electrostatic device, so as to allow to charge electrically said liquid product that is present inside said storing apparatus.

16. The device of claim 15, wherein said electrostatic device is adapted to provide, by way of the probe, a positive voltage that is between 10,000 and 60,000 volts so as to generate an electrical field that gives to said liquid product a positive charge.

17. The device of claim 16, wherein said electrostatic device is located within said first column at said tank.

18. The device of claim 3, further comprising a product delivery control apparatus that includes a compressor.

19. The device of claim 1, wherein the two individual foot-positioning regions include a scale for automatically detecting a body weight of a user.

20. The device of claim 4, wherein the electronic apparatus includes a processing unit; and wherein the device further comprises:
an interface device connected to said processing unit, wherein the interface device includes a display with a keypad and a reading apparatus configured to read portable memory devices that display, read and/or store and modify data related to body parameters of a user.

21. The device of claim 1, further comprising a second column, the second column being hollow and including, disposed therein, an air blowing apparatus configured to blow air said second column being arranged on said base such that when a user's feet rest in the two individual foot-positioning regions, the air blowing apparatus may blow air onto the user.

22. The device of claim 21, further comprising heating devices for heating air that exits from said air blowing apparatus.

23. The device of claim 21, further comprising speakers for playing back sounds, including music, during operation of the device.

24. A device for applying a cosmetic product to the human body, comprising:
a first column supported by a base;
at least one nozzle, attached to said first column;
an electrically pre-charged self-tanning or cosmetic product for spraying through said at least one nozzle;
two individual foot-positioning regions supported by the base, each of the foot-positioning regions being configured to receive a user's foot, wherein the foot-positioning regions are electrically connected to ground;
a second column having at least one delivery apparatus configured to discharge air, and an air blowing apparatus disposed within said second column, the air blowing apparatus being configured to blow air,
a tank configured to store said product in a liquid state;
pre-charging apparatus configured to pre-charge electrically said product in the tank before spraying thereof;
product delivery control apparatus configured to atomize the product.

25. A device for applying a cosmetic product to the human body, comprising:
a first column supported by a base;
at least one nozzle attached to said first column;
an electrically pre-charged self-tanning or cosmetic product that is sprayable through said nozzles;
pre-charging apparatus configured to pre-charge electrically said self-tanning or cosmetic product, the pre-charging apparatus being configured to be deactivated during said spraying; and
two individual foot-positioning regions supported by the base, each of the foot-positioning regions being configured to receive a user's foot, wherein the foot-positioning regions are electrically to ground.

26. The device of claim 6, wherein said tank has feet made of electrically insulating material on which it rests, said feet being adapted to act as insulators between said tank and said base.

27. The device of claim 25, wherein said foot-positioning regions are rotatable.

28. The device of claim 8, further comprising a series of pipes for connecting said inflow and outflow valves to a series of spray guns, which are controllable by electric valves and compressed air lines, the spray guns being made of antistatic plastic material and comprising an inlet for said liquid product, an inlet for spraying air to be mixed with said liquid product, and an inlet for air for activation of said spray gun.

29. The device of claim 28, wherein said spray guns comprise a mixing chamber, in which spraying air and liquid product are mixed at a first pressure for spraying air and a second pressure for the liquid product.

30. A device for applying a cosmetic product to the human body, comprising:
a base;
a supply of cosmetic product;
a first column supported by the base;
two individual foot-positioning regions supported by the base, each of the foot-positioning regions being configured to receive a user's foot, wherein the foot-positioning regions are each independently electrically connected to ground;
a plurality of nozzles in fluid connection with said supply of cosmetic product, the nozzles configured to be fed with said cosmetic product and spraying said product onto a body of a user when a user is positioned on the foot-positioning regions, said nozzles being mounted at said first column; and
an electrical apparatus, located upstream of said nozzles, the electrical apparatus being configured to electrically pre-charge the cosmetic product before feeding thereof for spraying at said nozzles.

31. A device for applying a cosmetic product to the human body, comprising:
a base;
a first column supported by the base;
at least one spraying nozzle, attached to said first column;
an electrically pre-charged self-tanning or cosmetic product for spraying through said at least one nozzle onto a body of a user, the product being pre-charged before spraying the product through said at least one nozzle;
a pressurized air source; and
two individual foot-positioning regions supported by the base, each of the foot-positioning regions being configured to receive a user's foot, wherein the foot-positioning regions are electrically connected to ground, and wherein said at least one nozzle comprises a mixing chamber for mixing of product and air fed thereto at pressure ratios that are selectable to provide a mixture that is dispensable in a spray jet with an adjustable breadth.

32. The device of claim 31, wherein said at least one nozzle comprises: a cylindrical body provided with a first axial channel for feeding a liquid and with second axial channels for feeding air; a covering element associable with said cylindrical body; a hollow dome, which is connected to said first channel; an upper opening, formed at said dome; a shank that protrudes radially from said dome, said shank having a plurality of ducts connected to said second channels, said covering element being shaped complementarily to said dome so as to form a chamber therewith; and a plurality of outlet holes and/or lateral slots formed at said covering element.

33. A device for applying a cosmetic product to the human body, that comprises:
a base;
a first column supported by the base;
an electrically pre-charged self-tanning or cosmetic product for spraying onto a body of a user, the product being pre-charged before the product spraying;
two individual foot-positioning regions supported by the base, each of the foot-positioning regions being configured to receive a user's foot, wherein the foot-positioning regions are electrically connected to ground,
a plurality of nozzles attached to said first column, each of which comprises: a cylindrical body provided with a first axial channel for feeding a liquid and with second axial channels for feeding air; a covering element associable with said cylindrical body; a hollow dome, which is connected to said first channel; an upper opening, formed at said dome; a shank that protrudes radially from said dome, said shank having a plurality of ducts connected to said second channels, said covering element being shaped complementarily to said dome so as to form a chamber therewith; and a plurality of outlet holes and/or lateral slots formed at said covering element.

34. A device for applying a cosmetic product to the human body, comprising:
a stand for a user made of elastically conducting material and electrically connected to ground;
at least one column;
at least one spraying nozzle, attached to said column;
an electrically pre-charged self-tanning or cosmetic product for spraying through said at least one nozzle onto a body of a user, the product being pre-charged before spraying the product through said nozzle.
